(19) United States
(12) Patent Application Publication
(10) Pub. No.: US 2021/0076277 A1
(43) Pub. Date: Mar. 11, 2021

(54) METHODS AND APPARATUSES FOR RAPID REROUTING IN A MULTI-HOP NETWORK

(71) Applicant: NOKIA TECHNOLOGIES OY, Espoo (FI)

(72) Inventor: Anup Talukdar, Naperville, IL (US)

(21) Appl. No.: 15/733,483

(22) PCT Filed: Feb. 7, 2019
(86) PCT No.: PCT/FI2019/050091

§ 371 Date: Aug. 7, 2020

Related U.S. Application Data
(60) Provisional application No. 62/628,545, filed on Feb. 9, 2018.

(51) Int. Cl. H04W 36/02; H04W 36/00; H04L 1/18; H04W 72/04; H04W 84/18; H04W 40/08

(52) U.S. Cl. CPC H04W 36/023; H04W 36/0055; H04W 40/08; H04W 72/042; H04W 84/18; H04L 1/18

(57) ABSTRACT

Systems, methods, apparatuses, and computer program products for rerouting data packets in multi-hop millimeterwave (mmWave) networks, such as in 5G or NR.

### FIELD

Some example embodiments may generally relate to mobile or wireless telecommunication systems. For instance, various example embodiments may relate to rapid rerouting of packets in such wireless telecommunication systems, such as a fifth generation (5G) radio access technology or new radio (NR) access technology.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), LTE-A Pro, and/or fifth generation (5G) radio access technology or new radio (NR) access technology. Fifth generation (5G) or new radio (NR) wireless systems refer to the next generation (NG) of radio systems and network architecture. It is estimated that 5G/NR will provide peak data rates on the order of approximately 10-20 Gbit/s (Gbps) or higher, and will support at least enhanced mobile broadband (eMBB) and ultra-reliable low-latency-communication (URLLC).

5G/NR is expected to deliver extreme broadband and ultra-robust, low latency connectivity and massive networking, for example, to support the Internet of Things (IoT). The target latency requirements are expected to be on the order of approximately 1 msec in order to serve applications with ultra-low latency performance requirements. Millimeter-wave (mmWave) frequency bands have been identified as a promising candidate for 5G cellular technology. Spectrum in traditional cellular bands, below 6 GHz, is finite and as cellular data traffic demand continues to grow new frequency bands are being considered. Unlike traditional cellular bands, large blocks of contiguous spectrum may be allocated at mmWave bands allowing for bandwidths on the order of GHz or more. It is noted that, in 5G or NR, the nodes that can provide radio access functionality to a user equipment (i.e., similar to Node B in E-UTRAN or eNB in LTE) may be referred to as a next generation or 5G Node B (gNB).

### BRIEF DESCRIPTION OF THE DRAWINGS

For proper understanding of the invention, reference should be made to the accompanying drawings, wherein:

FIG. 1 illustrates an example multi-hop millimeter-wave network, according to an embodiment;

FIG. 2 illustrates an example multi-hop millimeter-wave network, according to certain embodiments;

FIG. 3 illustrates an example multi-hop millimeter-wave network, according to certain embodiments;

FIG. 4a illustrates an example block diagram of an apparatus, according to one embodiment;

FIG. 4b illustrates an example block diagram of an apparatus, according to another embodiment;

FIG. 5a illustrates an example flow diagram of a method, according to one embodiment; and

FIG. 5b illustrates an example flow diagram of a method, according to another embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for rerouting data packets in radio access networks, such as 5G or NR, as represented in the attached figures and described below, is not intended to limit the scope of certain embodiments but is representative of selected example embodiments.

The features, structures, or characteristics of example embodiments described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

In addition to allowing for bandwidths on the order of GHz or more, the mmWave bands allow for multi-element antenna arrays composed of very small elements, on the order of integrate circuit (IC) chip scales, providing large antenna gain and sufficient power output through over-the-air power combining This combination of large bandwidths and novel device architectures allows mmWave cellular to provide peak rates on the order of 10 Gbps and ample capacity to meet future demands.

The propagation characteristics in the mmWave band are generally more challenging than traditional cellular. For example, the path-loss in the mmWave band is significantly higher. Diffraction at mmWave bands is effectively non-existent and propagation behaves similar to visible light. Transmission through most objects is diminished where foliage and other common obstacles can produce severe shadowing. Reflective power may offer new opportunities for completing the link, but may be 15 dB-40 dB weaker.

Access points (APs) in a mmWave network deployment may overcome the impacts of high path loss by using beamformed channels for all communications to achieve the required capacity and coverage. An access point (AP) may use a number of pre-selected narrow beams sufficient to cover its cell and it can also create customized narrow beams specific to a user equipment's (UE's) location using beam refinement procedure.

The severe shadowing loss characteristics in the mmWave band implies that, the radio link between a user device (UE) and its serving AP will be disrupted if the Line-Of-Sight (LOS) is blocked by obstacles. The LOS may be blocked by fixed obstacles, such as trees, or moving obstacle such as large trucks, or pedestrians. Other types of LOS blocking may be caused by user motions, such as hand or body rotations. In order to deliver reliable connectivity to a user in the presence of obstacles, a mmWave access point network may be built with enough redundancies of APs such that in the event of a LOS blocking, the network connection of the UE can be rapidly rerouted via another AP.

Due to high path loss, the coverage area of a mmWave AP is significantly smaller compared to that of a macro base station using a traditional cellular band. Typical values for inter-site distances in a mmWave deployment is about 200 m and thus a large number of APs may need to be deployed to cover a certain geographical area. Traditionally, the APs are connected to the core network via high capacity fiber links. However, connecting all these mmWave APs requires dense fiber connectivity, which may not be available at certain geographical regions such as city suburbs; even if they are available, connection cost may be significantly high and economically unfeasible.

An alternative and cost-effective solution for connecting these mmWave APs is to use in-band access and backhaul (JAB) where the same carrier band is used not only for the access links serving the UEs, but also to interconnect the APs to create a viable path from each AP to the core network. In this approach, the radio resources of an AP may be time-division multiplexed between its access and backhaul links. This sharing of the radio resources between the access and backhaul reduces the achievable system capacity significantly compared to a system with full fiber connectivity. Also, in deployments with sparse fiber connectivity, the link from an AP to the core network may include multiple hops of backhaul links, creating a multi-hop in-band access and backhaul network. In-band access and backhaul networks are also known as self-backhaul (sBH) networks, in which the APs without fiber connectivity are termed sBH APs.

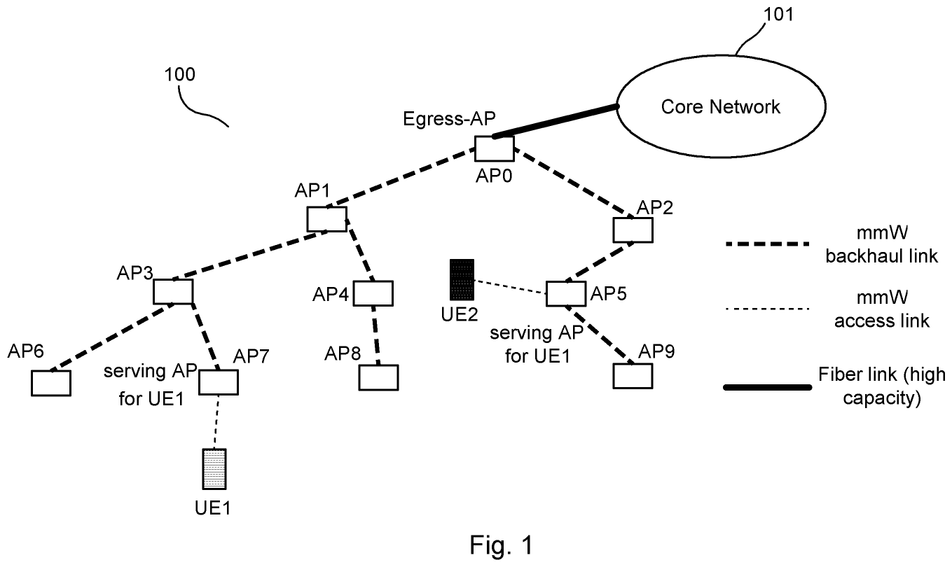

FIG. 1 illustrates an example multi-hop mmWave network 100, according to one embodiment. In the example network 100 of FIG. 1, AP0 is the egress AP that may be connected to the core network 101 via a high-capacity and low-latency link, such as a fiber-optic link. In this example, the other APs (AP1-AP9) may be inter-connected via mmWave links. As illustrated in the example of FIG. 1, the serving AP of the mobile terminal UE1 is AP7; the path between the egress AP0 and UE1 includes three backhaul links via AP1, AP3, AP7 and the access link of AP7.

Certain example embodiments may address at least the problem of reducing the data transfer latency during a handover of a UE. During the handover of a UE from its current serving AP (source-AP) to a new serving AP (target-AP), data packets buffered at the source-AP are forwarded to the target-AP. In a multi-hop mmWave IAB network, depending on the connection topology and routing scheme, the path from the source-AP to target-AP may include multiple wireless hops.

Thus, forwarding the buffered data during handover may have at least two impacts including, for example, air interface overheads and packet latency. With respect to air-interface overhead, forwarding the packets from the source-AP to target-AP may result in the packets traveling over some sBH links back and forth; also the route travelled by those packets to reach the new serving AP may not be the optimal route. This may result in undesirable use of the scarce radio resources in a IAB network. With respect to packet latency, since the path from the source-AP to the target-AP may include multiple wireless backhaul hops, packet latencies may exceed 5G latency targets. Accordingly, it is desirable to reduce the air-interface overhead and packet latency during UE handover to the extent possible. In certain embodiments described herein, at least these problems of reducing the air-interface overhead and latency are addressed.

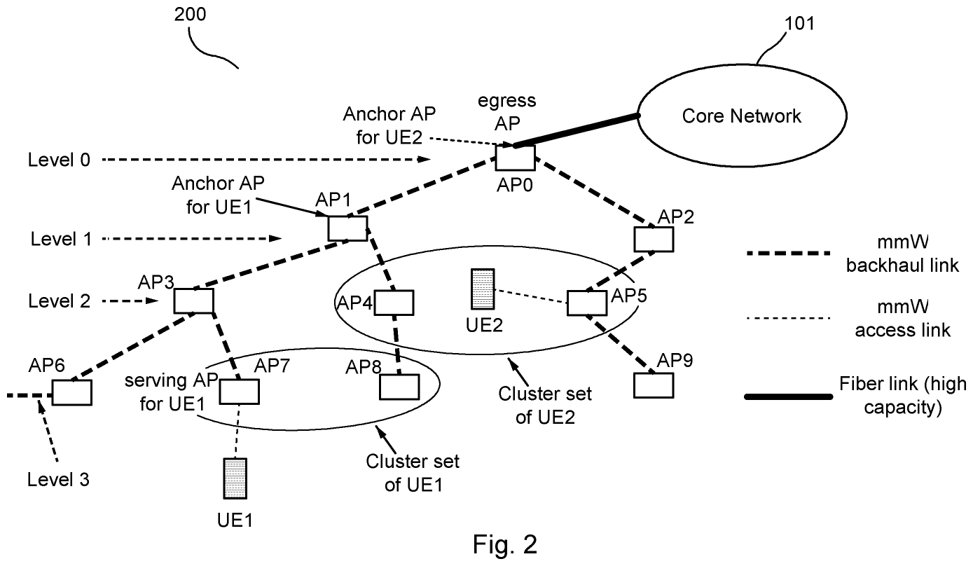

Since it is assumed that APs do not move, the connection topology among the APs is either static or semi-static. Some embodiments may be applicable in a connection topology where each self-backhaul AP is connected to an egress-AP via one or multiple hops of mmWave link(s). FIG. 2 illustrates an example multi-hop mmWave network 200, according to certain example embodiments. It is noted that the level of an AP may be determined by the number of sBH hops from the egress-AP (e.g., AP0 in FIG. 2), with the egress-AP being at level 0. According to an embodiment, an AP at level n maintains connectivity with one level n−1 AP over a mmWave link, termed as its parent AP. However, an AP at level n may maintain connectivity with more than one level n+1 APs, called its child APs. Thus, the mmWave links among a set of sBH APs and the egress-AP form a spanning tree rooted at the egress-AP.

Also, there is a unique route from each sBH AP to the egress-AP. For an AP at level n, the other APs in its path to the egress AP are termed as its ancestor. In the event of a failure of a mmWave link between two adjacent APs, one or more links may be reconfigured to maintain the connectivity; however, the reconfigured links preserve the spanning tree property. For example, an access point APᵢ covers APⱼ if APᵢ is an ancestor of APⱼ and, by definition, an AP covers itself.

In order to provide reliable connectivity in the presence of frequent radio link blockages, for each UE, the network may maintain a cluster set, Cₛ, which is a set of APs accessible to the UE. In an embodiment, an AP is accessible to a UE if the strength of the received signal from the AP at the UE is above a certain threshold, and the Cₛ of a UE includes a finite number of accessible APs. The UE may be served by one of the APs in Cₛ, called its serving-AP. When the link to its serving-AP is degraded or blocked, the UE may perform a fast handoff to another AP in Cₛ. For instance, in the example of FIG. 2, the cluster set for UE1 includes its serving AP7 and APB, and the cluster set for UE2 includes its serving AP5 and AP4.

A connection/flow from the network to the UE may include a radio resource control (RRC) connection from the egress-AP to the UE, which may pass via one or more sBH APs. The RRC connection may be managed by the RRC protocol entities in the network and the UE. During the connection setup procedure, radio bearers may be configured for the connection at each of the APs along the route from the egress-AP to the UE. A radio bearer may transport the data packets either to the next hop AP along the path towards the UE or to the final destination UE.

To route the data packets, each AP in the multi-hop network may maintain a routing table. For each destination address (which may be an access point or a UE attached to an access point) the routing table may include an entry indicating the next hop, which may be an access point or the destination UE, to which the packets will be forwarded. By definition, at any access point APₖ, the next hop for destination APₖ is APₖ. For a destination that is not in the sub-tree rooted at an access point AP, there is no next hop information in the routing table at AP; packets for those destinations are routed to the parent AP.

In certain example embodiments, a retransmission buffer for a UE may be created at an AP, designated as the anchor-AP, where the downlink packets of the UE can be buffered. In an embodiment, the anchor-AP may be the least common ancestor of the APs in the cluster set Cₛ as determined by the connection topology. When a handover of the UE occurs from a source AP in the Cₛ to a target AP in the Cₛ, the anchor-AP sends the packets from the buffer to the UE via the target AP. In the example network 200 of FIG. 2, the anchor-AP for UE1 is AP1 and the anchor-AP for UE2 is AP0.

Some example embodiments may provide certain functional procedures for the APs and UEs. For example, in an embodiment, an AP may receive a request for anchor-AP determination for a UE, the request may contain the cluster set for the UE. The UE may construct its cluster set by determining a number of accessible APs based on measurements of the synchronization channels of different APs. Upon receiving the request, the AP may determine that it is an anchor-AP for the UE, as will be discussed in more detail below. According to certain embodiments, the anchor-AP may set up a retransmission buffer for downlink packets for the UE. When the anchor-AP forwards a downlink (DL) packet to the UE via its serving-AP, the anchor-AP may store the packet in the retransmission buffer. Then, when the DL packets are successfully received at the UE, the UE may send an acknowledgement to the anchor-AP. When the acknowledgement arrives at the anchor-AP that the UE has received a packet, the anchor-AP may delete the packet from the retransmission buffer. When the UE hands off to another AP in the cluster set, the UE or the source AP or the target AP may send a request to the anchor-AP for retransmission of packets from the retransmission buffer. Upon receiving the request for retransmission, the anchor-AP may first re-send the packets from the retransmission buffer (which were forwarded earlier but not yet acknowledged) to the UE via the new serving-AP, and may also forward new packets to the UE via the new serving-AP.

According to certain embodiments, the retransmission buffer for the DL data for a UE may be located at the least common ancestor of the source and the target APs, which may not be the serving AP or the central unit (CU) that may be located at the egress-AP. In a multi-hop wireless deployment, this buffer location optimizes latency performance and the network overhead during handover.

Some embodiments may be directed to procedures for anchor AP configuration and for buffer management. In an embodiment, the anchor AP configuration may include steps for anchor AP determination and anchor buffer configuration.

According to certain embodiments, the anchor AP may be determined by the cluster set Cₛ of the UE. In some embodiments, there may be at least two methods for determining the cluster set Cₛ. For example, one method may be determining a pre-configured cluster set. This method may be desirable to enable fast handover in case of sudden radio link failures due to blockages by obstacles. In this case, Cₛ may include two or more accessible APs as determined by the UE scanning/measurements of the AP signals. Another method may be a handover-activated cluster set where Cₛ is configured when a handover of the UE is anticipated based on radio link measurements. In this case, Cₛ may include the source and the target APs in the handover procedure.

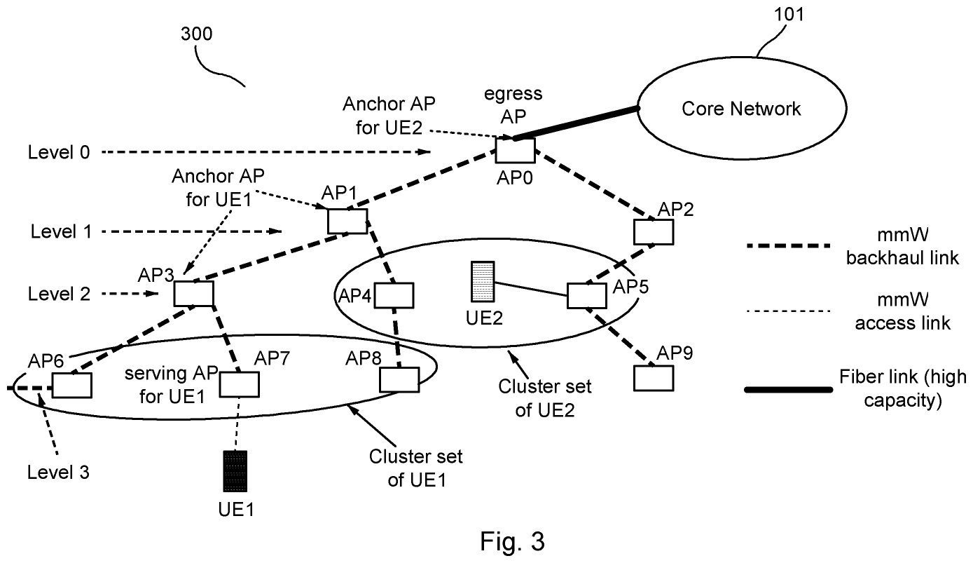

For some deployment scenario(s) and cluster set configuration(s), multiple anchor APs may be configured to further reduce data transmission latency during handover. FIG. 3 illustrates an example of such a deployment scenario in which the UE(s) of network 300 may have multiple anchor APs. In the example of FIG. 3, the cluster set of UE1 has three access points AP6, AP7 and AP8 to provide additional redundancy when the LOS to two APs are blocked. According to this example embodiment, UE1 has two anchor APs, which are AP3 and AP1. As one example, if the UE1 is unable to communicate with AP8 due to self-blocking and also its LOS to its serving AP (AP7) is blocked by a transient obstacle, UE1 may handover to AP6. Then, data from the retransmission buffer in AP3 may be forwarded reducing the latency (compared to forwarding from AP1).

In some embodiments, the anchor-AP configuration may be initiated by either the UE or the network. According to one embodiment, the anchor-AP configuration may be done when the cluster set is configured. Alternatively, in another embodiment, the anchor-AP configuration may be done when a RRC connection is established. Whenever the cluster set of the UE changes, or the backhaul connection topology changes, the anchor-AP may need to be configured again.

One embodiment may include a network initiated anchor-AP determination procedure. In this embodiment, the RRC protocol entity in the network may initiate the procedure by sending a request message to the egress-AP for the UE. According to one example, the request message may contain at least the cluster set information Cₛ. Upon receiving the request message for determination of anchor-AP(s) and buffer configuration, an access point APᵢ may execute a procedure for determining a single anchor-AP and/or for determining multiple anchor-APs.

In an embodiment, the determining of a single anchor-AP may include determining, from the routing table, the set of next hop APs, S_{Next}, for the destinations in the cluster set Cₛ. If S_{Next} contains more than one distinct next-hop APs, then APᵢ is designated as the anchor-AP for the UE and APᵢ creates the buffer for the UE. If S_{Next} does not contain more than one distinct next-hop APs, and if Sₙₑₓₜ is not empty, the request message may be forwarded to the AP in Sₙₑₓₜ.

In another embodiment, the determining of multiple anchor-APs may include determining, from the routing table, the set of next hop APs, S_{Next}, for the destinations in the cluster set Cₛ. If S_{Next} contains more than one distinct next-hop APs, then APᵢ is designated as the anchor-AP for the UE, APᵢ creates the buffer for the UE, and, for each access point APₙₑₓₜ in Sₙₑₓₜ, if APₙₑₓₜ is the next hop for (as determined by the routing table) more than one access points in Cₛ, the request message is forwarded to APₙₑₓₜ. If S_{Next} does not contain more than one distinct next-hop APs and if Sₙₑₓₜ is not empty, the request message is forwarded to the access point in Sₙₑₓₜ.

According to certain embodiments, if the cluster set is pre-configured, the RRC protocol entity in the network may send the request during the connection establishment procedure. In an embodiment, for handover-activated cluster set configuration, the RRC protocol entity may send the request when it sends the handover command to the UE.

Another embodiment may be directed to a UE initiated anchor-AP configuration procedure. In this embodiment, a UE may send an anchor-AP determination and buffer configuration request message to its serving-AP. The request message may contain the cluster set information Cₛ. Upon receiving a request message for determination of anchor-AP(s) and buffer configuration for a UE, an access point APᵢ may execute a procedure for determining a single anchor-AP and/or for determining multiple anchor-APs.

In an embodiment, the determining of a single anchor-AP may include, if APᵢ is an ancestor of all access points in Cₛ (i.e., the routing table at APᵢ contains an entry for each of the AP in Cₛ), APᵢ may be designated as the anchor-AP for the UE and APᵢ may create the buffer for the UE. If APᵢ is not an ancestor of all access points in Cₛ, then the request message may be forwarded to the parent access point.

In another embodiment, the determining of multiple anchor-APs may include setting AP_{from} to be equal to the AP from which the request arrived (AP_{from}=NULL if it arrived from a UE) and setting l to be equal to the level of APᵢ. From the routing table, the set of next hop APs, S_{Next}, is determined for the destinations in the cluster set Cs. If Sₙₑₓₜ contains more than one (distinct) access points, APᵢ is designated an anchor-AP for the UE and APᵢ creates the buffer for the UE. For each APₙₑₓₜ in Sₙₑₓₜ such that APₙₑₓₜ!=AP_{from}, if APₙₑₓₜ is the next hop (as indicated in the routing table entries at APᵢ) for more than one access points in Cₛ, the request message may be forwarded to APₙₑₓₜ. If APᵢ is not an ancestor of all access points in Cₛ and AP_{from} is a child of APᵢ, then the request message may be forwarded to parent of APᵢ.

According to some embodiments, if the cluster set is pre-configured, the UE may send the request message along with a connection establishment request, which may be a RRC connection request. For handover-activated cluster set configuration, the UE may send the request to the source AP or to the target AP, when it receives the command for handover to the target AP.

Other example embodiments may be directed to buffer management. According to one example, the packets in the buffer at the anchor-AP may be deleted after they are received by the UE. To accomplish this, in one embodiment, each UE packet arriving at the anchor-AP for transmission to the UE may have a sequence number assigned to it. This sequence number may be allocated by the egress AP or by the anchor AP (at the lowest level when there are multiple-Anchor APs for a UE), for example. After the UE receives a packet, it may send an acknowledgement message to the anchor AP(s) containing the sequence number of the received packet. After receiving the acknowledgement, the anchor AP(s) may then delete the packet from the buffer.

In one embodiment, the Packet Data Convergence Protocol (PDCP) layer for the radio bearer may be implemented at the egress AP and UE; the intermediate APs in the routes to the UE does not perform PDCP layer processing of the packet, although it may perform PHY, MAC and RLC layer processing. According to an example, after RLC layer processing on the packets received from the egress AP, the anchor AP can access the PDCP sequence number (SN) assigned at the egress AP and save it along with the packet in the buffer. The UE may use the PDCP SN in the acknowledgement message to the anchor AP to identify the packets it received successfully. The anchor-AP may also utilize the PDCP status report that travels on the reverse path from the UE to the egress-AP to identify and delete packets which have been received by the UE.

In another embodiment, the PDCP layer for the RRC connection to the UE may be implemented at the anchor-AP and the UE end-to-end. The PDCP status update sent by the UE containing information of the PDCP PDUs received may be used to delete the packets from the buffer as part of PCDP layer processing.

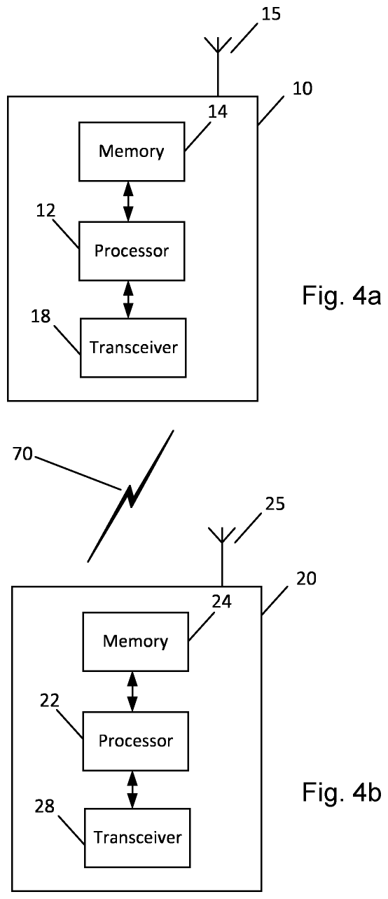

FIG. 4a illustrates an example of an apparatus 10 according to an embodiment. In an embodiment, apparatus 10 may be a node, host, or server in a communications network or serving such a network. For example, apparatus 10 may be a base station, a Node B, an evolved Node B (eNB), 5G Node B or access point, next generation Node B (NG-NB or gNB), WLAN access point, mobility management entity (MME), and/or subscription server associated with a radio access network, such as a GSM network, LTE network, 5G or NR.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. It should be noted that one of ordinary skill in the art would understand that apparatus 10 may include components or features not shown in FIG. 4a.

As illustrated in the example of FIG. 4a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 4a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like. According to certain embodiments, apparatus 10 may be controlled by memory 14 and processor 12 to perform the functions associated with any of the embodiments described herein, such as the signaling or block diagrams illustrated in FIGS. 1-3. For example, in certain embodiments, apparatus 10 may be controlled by memory 14 and processor 12 to perform one or more of the steps performed by the APs illustrated in FIGS. 1-3. In certain embodiments, for instance, apparatus 10 may be configured to perform rapid rerouting of packets in a multi-hop network, such as a mmWave 5G network.

For instance, in some embodiments, apparatus 10 may be controlled by memory 14 and processor 12 to receive a request for determining the anchor-AP for a UE. The request may include the cluster set information for the UE. When apparatus 10 receives the request, apparatus 10 may be controlled by memory 14 and processor 12 to determine that it is an anchor-AP for the UE based on the cluster set information of the UE. Thus, in an embodiment, the anchor-AP may be determined by the cluster set information of the UE. In turn, as discussed above, the cluster set for a UE may be pre-configured, or the cluster set may be configured when a handover of the UE is anticipated based on radio link measurements.

According to some embodiments, the determination and/or configuration of the anchor-AP may be initiated by the UE or the network. For example, in one embodiment, the anchor-AP may be configured when the cluster set is configured. Alternatively, in another embodiment, the anchor-AP may be configured when RRC connection is established. In addition, in some examples, when the cluster set of the UE changes or the backhaul connection topology changes, the anchor-AP may be configured again. In some example embodiments, whether the configuration of the anchor-AP is UE-initiated or network-initiated, apparatus 10 may be controlled to perform either of the procedures for determining a single anchor-AP or the procedures for determining multiple anchor-APs, as discussed in detail above.

Furthermore, in certain embodiments, after determining that apparatus 10 is an anchor-AP for the UE, apparatus 10 may be controlled by memory 14 and processor 12 to set up or configure a retransmission buffer for DL packets for the UE. Then, when apparatus 10 forwards a DL packet to the UE via the UE's serving-AP, apparatus 10 may be controlled by memory 14 and processor 12 to store or buffer the packet in the retransmission buffer. In certain example embodiments, apparatus 10 may be controlled by memory 14 and processor 12 to assign a sequence number to each packet arriving for transmission to the UE. For example, in an embodiment where the PDCP layer for the radio bearer is implemented at the egress AP and UE, after RLC layer processing on the packets received from the egress AP, apparatus 10 may be controlled by memory 14 and processor 12 to access the PDCP sequence number assigned at the egress AP and save it along with the packet in the retransmission buffer.

When the UE successfully receives the DL packets, the UE may send acknowledgement (ACK) message to apparatus 10. Accordingly, after successful receipt of the DL packets at the UE, apparatus 10 may be controlled by memory 14 and processor 12 to receive the ACK message and, when the ACK message arrives, apparatus 10 may be controlled by memory 14 and processor 12 to delete the acknowledged packet from the retransmission buffer. In an example embodiment, when a sequence number has been assigned to the packet, the ACK message received from the UE may include the sequence number of the acknowledged packet.

According to some embodiments, when the UE hands off to another AP in its cluster set, apparatus 10 may be controlled by memory 14 and processor 12 to receive, from the UE or source AP or target AP, a request for retransmission of packets from the retransmission buffer. Upon receiving the request for retransmission, apparatus 10 may be controlled by memory 14 and processor 12 to re-send the packets from the retransmission buffer (which were forwarded earlier but not yet acknowledged) to the UE via the new serving-AP, and to also forward all new packets to the UE via the new serving-AP. It is noted that, according to example embodiments, the retransmission buffer for the DL data for a UE is located at the least common ancestor of the source and the target APs (which may or may not be the serving AP).

FIG. 4b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, UE may alternatively be referred to as, for example, a mobile station, mobile equipment, mobile unit, mobile device, user device, subscriber station, wireless terminal, tablet, smart phone, IoT device or NB-IoT device, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 4b.

As illustrated in the example of FIG. 4b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 10 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, mobile device, mobile station, ME, IoT device and/or NB-IoT device, for example. According to certain embodiments, apparatus 20 may be controlled by memory 24 and processor 22 to perform the functions associated with embodiments described herein. For example, in some embodiments, apparatus 20 may be configured to perform one or more of the processes depicted in any of the flow charts or block diagrams described herein, such as the flow or block diagrams illustrated in FIGS. 1-3.

According to some embodiments, apparatus 20 may be controlled by memory 24 and processor 22 to send an anchor-AP determination and buffer configuration request message to a serving-AP. In an embodiment, the request message may include the cluster set information for the apparatus 20. According to one example, when the cluster set is pre-configured, apparatus 20 may send the request message along with a connection establishment request, which may be a RRC connection request message, for instance. In another example, when the cluster set configuration is triggered by an anticipated handover, apparatus 20 may send the request message when apparatus 20 receives the command for handover to the target-AP.

In certain embodiments, on receiving the request message, the serving-AP may determine that it is an anchor-AP for apparatus 20 and may configure a retransmission buffer for storing DL packets for apparatus 20 when the anchor-AP forwards a DL packet to apparatus 20. According to an embodiment, apparatus 20 may be controlled by memory 24 and processor 22 to receive DL packet(s) from the anchor-AP and, when it successfully receives the DL packets, apparatus 20 may be controlled by memory 24 and processor 22 to send an ACK message to the anchor-AP. When the ACK arrives at the anchor-AP that apparatus 20 has received a packet, the anchor-AP may delete the packet from the retransmission buffer.

According to some example embodiments, when apparatus 20 hands off to another AP in the cluster set, apparatus 20 may be controlled by memory 24 and processor 22 to transmit a request to the anchor-AP for retransmission of packets from the retransmission buffer. In an embodiment, apparatus 20 may then be controlled by memory 24 and processor 22 to receive the packets from the retransmission buffer and/or new packets from the anchor-AP via a new serving-AP.

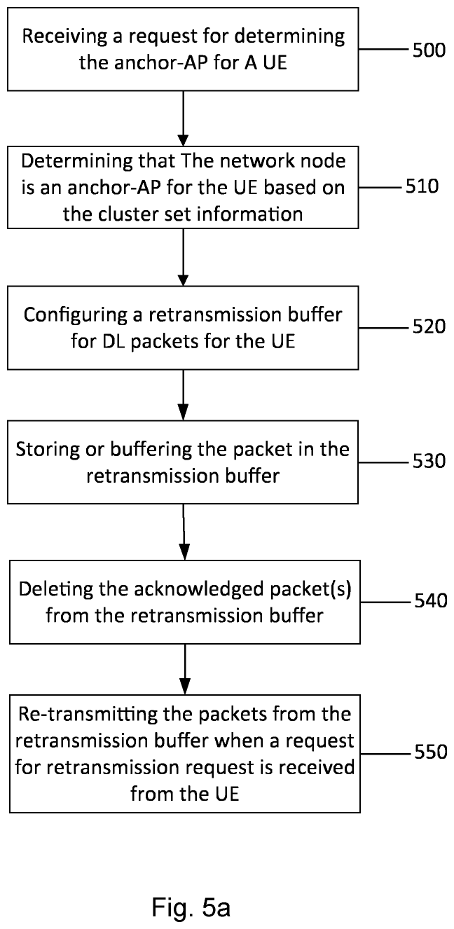

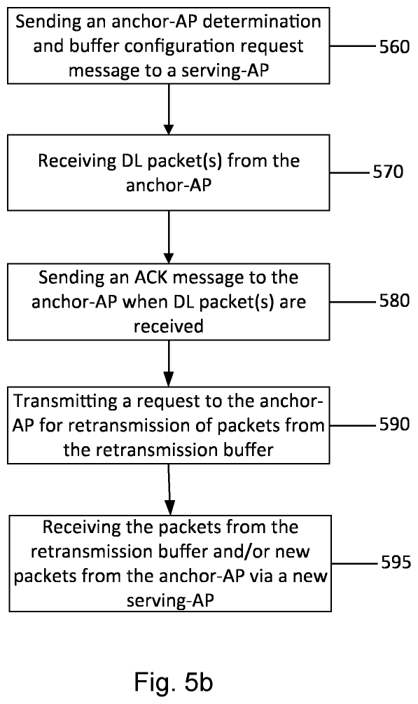

FIG. 5a illustrates an example flow diagram of a method for rapid rerouting in a multi-hop network, such as a mmWave 5G network, according to one embodiment. In certain embodiments, the flow diagram of FIG. 5a may be performed by a network node, such as an access point, base station, node B, eNB, gNB, or any other access node. As illustrated in the example of FIG. 5a, the method may include, at 500, a network node receiving a request for determining the anchor-AP for a UE. The request may include the cluster set information for the UE. When the network node receives the request, the method may include, at 510, determining that it is an anchor-AP for the UE based on the cluster set information of the UE. Thus, in an embodiment, the anchor-AP may be determined by the cluster set information of the UE. As discussed above, in certain embodiments, the cluster set for a UE may be pre-configured, or the cluster set may be configured when a handover of the UE is anticipated based on radio link measurements.

According to some embodiments, the determining 510 of the anchor-AP may be initiated by the UE or the network. For example, in one embodiment, the anchor-AP may be configured when the cluster set is configured. Alternatively, in another embodiment, the anchor-AP may be configured when RRC connection is established. In addition, in some examples, when the cluster set of the UE changes or the backhaul connection topology changes, the anchor-AP may be configured again. In some example embodiments, whether the configuration of the anchor-AP is UE-initiated or network-initiated, the determining 510 may include performing either of the procedures for determining a single anchor-AP or the procedures for determining multiple anchor-APs, as discussed in detail above.

Furthermore, in certain embodiments, after determining that the network node is an anchor-AP for the UE, the method may include, at 520, configuring a retransmission buffer for DL packets for the UE. Then, the method may include forwarding a DL packet to the UE via the UE's serving-AP, and the method may include, at 530, storing or buffering the packet in the retransmission buffer. In certain example embodiments, the method may include assigning a sequence number to each packet arriving for transmission to the UE. For example, in an embodiment where the PDCP layer for the radio bearer is implemented at the egress-AP and UE, after RLC layer processing on the packets received from the egress-AP, the method may include accessing the PDCP sequence number assigned at the egress AP and saving it along with the packet in the retransmission buffer.

When the UE successfully receive the DL packets, the UE may send acknowledgement (ACK) message to the network node. Accordingly, after successful receipt of the DL packets at the UE, the method may include receiving the ACK message and, when the ACK message arrives, the method may include, at 540, deleting the acknowledged packet(s) from the retransmission buffer. In an example embodiment, when a sequence number has been assigned to the packet, the ACK message received from the UE may include the sequence number of the acknowledged packet.

According to some embodiments, when the UE hands off to another AP in its cluster set, the method may include receiving, from the UE or source AP or target AP, a request for retransmission of packets from the retransmission buffer. Upon receiving the request for retransmission, the method may include, at 550, re-transmitting the packets from the retransmission buffer (which were forwarded earlier but not yet acknowledged) to the UE via the new serving-AP, and/or forwarding all new packets to the UE via the new serving-AP. It is noted that, according to example embodiments, the retransmission buffer for the DL data for a UE is located at the least common ancestor of the source and the target APs.

FIG. 5b illustrates an example flow diagram of a method for rapid rerouting in a multi-hop network, such as a mmWave 5G network, according to one embodiment. In certain embodiments, the flow diagram of FIG. 5b may be performed, for example, by a UE, mobile station, mobile equipment, IoT device, or the like. As illustrated in the example of FIG. 5b, the method may include, at 560, sending an anchor-AP determination and buffer configuration request message to a serving-AP. In an embodiment, the request message may include the cluster set information for the UE. According to one example, when the cluster set is pre-configured, the sending 560 may include sending the request message along with a connection establishment request, which may be a RRC connection request message, for instance. In another example, when the cluster set configuration is triggered by an anticipated handover, the sending 560 may include sending the request message when the UE receives the command for handover to the target-AP.

In certain embodiments, when the serving-AP receives the request message, it may determine that it is an anchor-AP for the UE and may configure a retransmission buffer for storing DL packets for the UE when the anchor-AP forwards a DL packet to the UE. According to an embodiment, the method may also include, at 570, receiving DL packet(s) from the anchor-AP. When the UE successfully receives the DL packets, the method may include, at 580, sending an ACK message to the anchor-AP. When the ACK arrives at the anchor-AP that the UE has received a packet, the anchor-AP may delete the packet from the retransmission buffer. According to some example embodiments, when the UE hands off to another AP in its cluster set, the method may include, at 590, transmitting a request to the anchor-AP for retransmission of packets from the retransmission buffer. In an embodiment, the method may also include, at 595, receiving the packets from the retransmission buffer and/or new packets from the anchor-AP via a new serving-AP.

Therefore, certain example embodiments provide several technical improvements, enhancements, and/or advantages. Various example embodiments are able to reduce packet latencies during handover compared to conventional approaches, since according to certain examples packets may be retransmitted from the least common ancestor node (instead of the source AP or CU). In addition, as a result of certain embodiments, network overhead is lower compared to conventional approaches at least because packets are delivered over optimal routes, avoiding wireless overheads of packets traveling over retracted routes to reach the target-AP. Example embodiments can perform buffering node determination using a distributed algorithm by message passing, which makes the system tolerant to failures of the central entity performing the anchor-AP determination in a centralized scheme.

As such, example embodiments can improve performance, latency, and/or throughput of networks and network nodes including, for example, access points, base stations/eNBs/gNBs, and mobile devices or UEs. Accordingly, the use of certain example embodiments result in improved functioning of communications networks and their nodes.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and include program instructions to perform particular tasks.

A computer program product may comprise one or more computer-executable components which, when the program is run, are configured to carry out some example embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to an embodiment, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One embodiment is directed to a method that may include determining, by a network node, that it is an anchor-AP for a UE based on cluster set information of the UE. The method may also include configuring, by the anchor-AP, a retransmission buffer for DL packets for the UE. The method may then include storing or buffering the DL packet(s) in the retransmission buffer. After successful receipt of the DL packets at the UE, the method may include receiving an acknowledgement message and, when the acknowledgement message arrives, the method may include deleting the acknowledged packet from the retransmission buffer. In an example embodiment, when a request for handover of the UE is received, the method may include re-transmitting the packets from the retransmission buffer to the UE via a new serving-AP.

Another embodiment is directed to an apparatus that may include at least one processor and at least one memory comprising computer program code. The at least one memory and computer program code may be configured, with the at least one processor, to cause the apparatus at least to determine that the apparatus is an anchor-AP for a UE based on cluster set information of the UE, and to configure a retransmission buffer for DL packets for the UE. The at least one memory and computer program code may be further configured, with the at least one processor, to cause the apparatus at least to store or buffer the DL packet(s) in the retransmission buffer and, after successful receipt of the DL packets at the UE, to receive an acknowledgement message. When the acknowledgement message arrives, the at least one memory and computer program code may be further configured, with the at least one processor, to cause the apparatus at least to delete the acknowledged packet from the retransmission buffer. In an example embodiment, when a request for handover of the UE is received, the at least one memory and computer program code may be further configured, with the at least one processor, to cause the apparatus at least to re-transmit the packets from the retransmission buffer to the UE via a new serving-AP.

Another embodiment is directed to a method that may include sending an anchor-AP determination and buffer configuration request message to a serving-AP. According to an embodiment, the method may also include receiving DL packet(s) from the anchor-AP. When the UE successfully receives the DL packets, the method may include sending an ACK message to the anchor-AP. According to some example embodiments, when the UE hands off to another AP in its cluster set, the method may include transmitting a request to the anchor-AP for retransmission of packets from the retransmission buffer. In an embodiment, the method may also include receiving the packets from the retransmission buffer and/or new packets from the anchor-AP via a new serving-AP.

Another embodiment is directed to an apparatus that may include at least one processor and at least one memory comprising computer program code. The at least one memory and computer program code may be configured, with the at least one processor, to cause the apparatus at least to send an anchor-AP determination and buffer configuration request message to a serving-AP. According to an embodiment, the at least one memory and computer program code may be further configured, with the at least one processor, to cause the apparatus at least to receive DL packet(s) from the anchor-AP. When the UE successfully receives the DL packets, the at least one memory and computer program code may be further configured, with the at least one processor, to cause the apparatus at least to send an ACK message to the anchor-AP. According to some example embodiments, when the UE hands off to another AP in its cluster set, the at least one memory and computer program code may be further configured, with the at least one processor, to cause the apparatus at least to transmit a request to the anchor-AP for retransmission of packets from the retransmission buffer. In an embodiment, the at least one memory and computer program code may be further configured, with the at least one processor, to cause the apparatus at least to receive the packets from the retransmission buffer and/or new packets from the anchor-AP via a new serving-AP.

One having ordinary skill in the art will readily understand that example embodiments as discussed above may be practiced with steps in a different order, and/or with hardware elements in configurations which are different than those which are disclosed. Therefore, although certain embodiments have been described based upon these preferred embodiments, it would be apparent to those of skill in the art that certain modifications, variations, and alternative constructions would be apparent, while remaining within the spirit and scope of example embodiments.

1. An apparatus comprising:
at least one processor,
at least one memory including a computer program code,
wherein the at least one memory and the computer program code are configured to, with the at least one processor, cause the apparatus at least to perform a process, the process comprising:
receive, by a network node, a request for determining an anchor access point for a user device for data routing in a multi-hop network with regard to a handover;
determine that the network node is the anchor access point for the user device based on in a cluster set information, wherein the cluster set information comprises access points of the multi-hop network accessible to the user device;
configure a retransmission buffer for downlink packets for the user device;
store or buffering at least one downlink packet in the retransmission buffer and forward the at least one downlink packet to the user device via a first serving access point of the user device;
when the user device has successfully received the at least one downlink packet,
delete the at least one downlink packet from the retransmission buffer, and
upon receiving a request for retransmission of the at least one downlink packet,
re-transmit the at least one downlink packet from the retransmission buffer to the user device via a second serving access point of the user device.

2. The apparatus of claim 1, wherein the network node is the least common ancestor of the access points accessible to the user device.

3. The apparatus of claim 1, wherein the user device having successfully received the at least one downlink packet is determined based on reception of an acknowledgement.

4. The apparatus of claim 1, further comprising causing the apparatus to forward new downlink packets to the user device via the second serving access point.

5. The apparatus of claim 1, wherein the determining the anchor access point is network-initiated or user device-initiated.

6. A method comprising:
receiving, by a network node, a request for determining an anchor access point for a user device for data routing in a multi-hop network with regard to a handover;
determining that the network node is the anchor access point for the user device based on in a cluster set information, wherein the cluster set information comprises access points of the multi-hop network accessible to the user device;
configuring a retransmission buffer for downlink packets for the user device;
storing or buffering at least one downlink packet in the retransmission buffer and forwarding the at least one downlink packet to the user device via a first serving access point of the user device;
when the user device has successfully received the at least one downlink packet,
deleting the at least one downlink packet from the retransmission buffer, and
upon receiving a request for retransmission of the at least one downlink packet,
re-transmitting the at least one downlink packet from the retransmission buffer to the user device via a second serving access point of the user device.

7. The method of claim 6, wherein the network node is the least common ancestor of the access points accessible to the user device.

8. The method of claim 6, wherein the user device having successfully received the at least one downlink packet is determined based on reception of an acknowledgement.

9. The method of claim 6, further comprising:
forwarding new downlink packets to the user device via the second serving access point.

10. The method of claim 6, wherein the determining the anchor access point is network-initiated or user device-initiated.

11. An apparatus comprising:
at least one processor,
at least one memory including a computer program code,
wherein the at least one memory and the computer program code are configured to, with the at least one processor, cause the apparatus at least to perform a process, the process comprising:
carry out a handover from a first serving access point to a second serving access point within a cluster set, wherein the cluster set comprises access points accessible to the user device in a multi-hop network;
transmit a request to an anchor access point for retransmission of at least one downlink packet for data routing with regard to the handover, wherein the anchor access point is a least common ancestor of the access points accessible to the user device, and
in response to successful reception of the at least one downlink packet,
send an acknowledgement to the anchor access point.

12. The apparatus of claim 11, further comprising causing the apparatus to receive at least one new downlink packet from the anchor access point via the second serving access point.

13. The apparatus of claim 11, further comprising causing the apparatus to send an anchor access point determination and buffer configuration request message to the first serving access point prior to the handover, wherein the message comprises a cluster set.

14. The apparatus of claim 11, wherein the handover is carried out due to a radio link degradation or block in the path between the first serving access point and the user device.

15. The apparatus of claims 11, further comprising causing the apparatus to construct the cluster set by determining a number of accessible access points based on measurements of synchronization channels.

16. A method comprising:
carrying out a handover from a first serving access point to a second serving access point within a cluster set, wherein the cluster set comprises access points accessible to the user device in a multi-hop network;
transmitting a request to an anchor access point for retransmission of at least one downlink packet for data routing with regard to the handover, wherein the anchor access point is a least common ancestor of the access points accessible to the user device, and
in response to successful reception of the at least one downlink packet,
sending an acknowledgement to the anchor access point.

17. The method of claim 16, further comprising: receiving at least one new downlink packet from the anchor access point via the second serving access point.

18. The method of claim 16, further comprising:
sending an anchor access point determination and buffer configuration request message to the first serving access point prior to the handover, wherein the message comprises a cluster set.

19. The method of claim 16, wherein the handover is carried out due to a radio link degradation or block in the path between the first serving access point and the user device.

20. The method of claim 16, further comprising: constructing the cluster set by determining a number of accessible access points based on measurements of synchronization channels.
